(19) United States
(12) Patent Application Publication
(10) Pub. No.: US 2006/0127155 A1
(43) Pub. Date: Jun. 15, 2006

(54) Continuous decorative thermal print

(75) Inventors: Cheryl J. Brickey, Webster, NY (US); Robert P. Bourdelais, Pittsford, NY (US); John M. Palmeri, Hamlin, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/011,882

(22) Filed: Dec. 14, 2004

(51) Int. Cl. B41J 2/315

(52) U.S. Cl. 400/120.1

(57) ABSTRACT

The invention relates to a decorative thermal print comprising a continuous thermal print material comprising a thermal image on a pragmatic layer, a protective layer over the print, and an adhesive layer on the opposite side of said pragmatic layer from said image.

### FIELD OF THE INVENTION

This invention relates to a decorative thermal print materials suitable for wall decorations and more particularly, a continuous thermal print material with a repeating pattern without spacing between pattern repeats.

### BACKGROUND OF THE INVENTION

Hanging of wallpaper or a wallpaper boarder is becoming a popular do-it-yourself product for many homeowners, and is often undertaken by a homeowner having limited experience in such a project. It represents a convenient way of decorating a room to reflect the chosen fashion of the homeowner. To decorate the wall, wallpaper is placed and applied to the wall by applying and/or spreading paste on the backside of the wallpaper, followed by placing the back side of the paper to the wall. Thereafter, the wallpaper is smoothed against the wall by a variety of tools.

Wallpaper or wall boarders are typically printed on gravure printing machine utilizing several printing stations to prints the graphic designs that are popular subject matter for wallpaper. Since wallpaper is printed on large, productive machine, wallpaper inventory and a limited selection is a current reality of the business model as long runs on the printing press are required to off-set the considerable expense of press make ready. Further, customization of wall decoration with photographs, images and text is very difficult because of the printing presses currently used to produce wall decorations.

U.S. Pat. No. 5,824,363, to Poole et al., teaches a wallpaper pasting machine having a lid and a trough. The lid can completely cover the trough to keep the paste from further drying out. An applying roller for applying paste to wallpaper is placed within the inner compartment of the trough. A scraper bar is mounted at the rear portion of the trough, and the scraper bar scrapes excess paste from wallpaper. A snap lock located on the lid is used to secure the lid to the trough. Paper tension ribs are located in the interior portion of the lid for providing tension on the wallpaper and for guiding and pressing the wallpaper to the applying roller to apply paste onto the wallpaper as the wallpaper is pulled through the machine. A return roller can be adjusted in position and held to one of three sets of holes that are on the lid. The position adjustment of the return roller allows the thickness of paste that is applied to the wallpaper to be varied. The pasting machine can be mounted, attached, or fixed to a surface. Paste is applied to the wallpaper being generally placed over the applying roller, pulled through pasting machine, and pulled around and over return roller.

U.S. Pat. No. 5,795,387, to Huerta, discloses a paste applying apparatus including a trough having an upstream end, a downstream end and opposing sidewalls, an applicator roller carried by the trough, and an adjustable scraper bar carried by the trough upstream of and adjacent to the applicator roller. The apparatus includes an adjustment assembly for adjusting the scraper bar for allowing a user to adjust the amount of paste removed from the surface of the wallpaper, a lid removably and hingedly coupled to the trough for movement between an open position and a closed position, and an outfeed roller carried proximate the trough upstream of the scraper bar.

U.S. Pat. No. 5,421,886, to Poole et al., relates to a paste dispenser having a paste reservoir and an applicator for containing and applying paste to wallpaper. A package having a container and a base, transformable between a package configuration wherein the paste dispenser is received within the container and the container is closed by the base, and an applicator configuration wherein the base extends from the container and carries the paste dispenser. Arresting means is provided in contact with the wallpaper for limiting the flow of paste from the paste dispenser.

U.S. Pat. No. 5,336,323, to Cotton et al., teaches a wallpaper dispenser for automatically hydrating a film of glue pre-applied to one side of a roll of wallpaper. The dispenser includes a reservoir having a roll of wallpaper rotatably supported thereover and a roller for guiding the wallpaper within a quantity of water contained within the reservoir. A ramp is provided for cutting the wallpaper and includes a cutting ridge along which a cutting member is drawn to cut the wallpaper perpendicular to the length thereof. A tape measure and means for securing the tape measure adjacent the ridge are provided to indicate the point, forwardly of the ridge, adjacent, which the forward margin of the wallpaper should be positioned. A slidable member is provided to automatically align the pattern on one strip of the wallpaper with the same pattern on a previously cut strip when the strips are positioned in laterally adjacent relation and with the top margins thereof in alignment.

U.S. Pat. No. 5,330,575, to Poole et al., discloses apparatus for applying paste, which apparatus includes a trough having an upstream end and a downstream end removably carrying an applicator roller rotated by driving means and a scraper bar. The scraper bar is upstream of and adjacent the applicator roller with a pressure area downstream of the applicator roller. A lid hingedly coupled to the trough, carrying an outfeed roller downstream of the scraper bar, is provided for guiding wallpaper over the applicator roller and the scraper bar.

U.S. Pat. No. 5,230,737, to Takada et al., relates to a wallpaper pasting apparatus characterized in that the wallpaper pasting apparatus is provided with a pasting roller and a pressing guide for pressing the wallpaper against the upper surface thereof, by a plurality of leveling plate means having edge wavy grooves for adjusting the thickness of the paste layer transferred onto the wallpaper.

U.S. Pat. No. 4,159,695, to Newman, teaches a wallpaper paste applicator comprising a container having an inclined trap bottom portion along which a strip of wallpaper travels with its decorative surface facing downward. The paper is pulled through a slot in the forward portion of the apparatus formed by a vertically adjustable wall and the bottom of the tray. A quantity of paste is maintained on top of the wallpaper in the tray, and is distributed to the back of the paper by a flexible notched wiping bar.

### PROBLEM TO BE SOLVED BY THE INVENTION

There is a need for wall decorations that can be customized by consumers at point of purchase and printed on a media continuously, without seams between patterns.

### SUMMARY OF THE INVENTION

It is an object of the invention to provide a digitally printed wall decoration media.

It is another object to provide a media that contains repeating pattern without spaces between patterns.

It is a further object to a digital template for insertion of consumer-selected images.

These and other objects of the invention are accomplished by a decorative thermal print comprising a continuous thermal print material comprising a thermal image on a pragmatic layer, a protective layer over the print, and an adhesive layer on the opposite side of said pragmatic layer from said image.

### ADVANTAGEOUS EFFECT OF THE INVENTION

The invention provides a continuous thermally printed decorative print material capable of being applied to walls, ceilings or automotive bodies. In one preferred embodiment, the invention provides consumers a method for customization of wall decorations.

### BRIEF DESCRIPTION OF THE DRAWINGS

FIG. 1 is an illustration of a decorative thermal print in which consumer custom image content corresponds to a thermal dye transfer printed template.

### DETAILED DESCRIPTION OF THE INVENTION

The invention has numerous advantages. The invention provides a decorative thermal print material that can be customized at the time of creation. Prior art wall decorations such as wallpaper, wall boarders or posters are typically ink printed on printing presses. The current state of the decorative market does not easily allow for customization of wall decorations such as personal images, special text messages or special graphic or pattern. The invention provides a means for consumers to customize decorative materials at the time of printing as the decorative materials can be digitally printed at point of purchase. Further, the invention allows the consumer to print a sample or several samples of the created decoration to take home for a design decision avoiding the need to take home heavy and bulky wallpaper sample books. Because samples of customized decorations can be digitally saved, final orders printing can be executed over the phone saving consumers trips to home decoration centers.

The invention provides a repeating pattern of text, images or decorative designs that are printed continuously in rolls. Further, the invention allows for the printing of repeat patterns, which are common for wall decorations, without undesirable spaces between the repeat patterns. The invention also provides a novel means for adhering decorative materials to wall. The invention utilizes a removable pressure sensitive adhesive, avoiding the need for messy and difficult to manipulate wallpaper paste. The invention also provides a protective layer for the printed decorative content, protecting the content against scratches, UV fade, wear and tear from children and water. These and other advantages will be apparent from the detailed description below.

As used herein, the term “continuous” means a length greater than 10 meters in length. The term “continuous” refers to the length of a printed decorative media roll and is distinguished from printed sheets, which are discontinuous. The term used herein “peelable adhesive” or “repositionable adhesive” means an adhesive material that has a peel strength less than 100 grams/cm. The term used herein “permanent adhesive” means an adhesive materials that has peel strength of greater than 100 grams/cm.

In order to accomplish a decorative print material that can be continuously printed in a repeating pattern without spacing between pattern repeats, a decorative thermal print comprising a continuous thermal print material comprising a thermal image on a pragmatic layer, a protective layer over the print, and an adhesive layer on the opposite side of said pragmatic layer from said image is preferred. Thermal printing of the decorative element allows for digital creation of the decorative content and provides very high, photographic quality output that is consistent with consumer images that could be contained in the decorative content. The protective layer applied over the thermal print, protects the decorative content against scratching and handling which would decrease the quality of the decorative content. The decorative thermal print is provided with an adhesive, which allows for the printed decorative material to be applied to desired surfaces such as painted walls, ceilings, windows or automotive bodies.

A layer structure example of decorative print material that is continuously printed in a repeating pattern without spacing between pattern repeats is as follows:

Polymer protective layer
Thermal dye transfer printed dye receiving layer
Pragmatic sheet
Removable pressure sensitive adhesive
Carrier sheet

The decorative thermal print preferably comprises a repeating pattern without spacing between pattern repeats. Prior art wall decorations typically comprise repeat graphic patterns whose repeat frequency is the circumference of the printing rolls utilized during printing. Ink printed prior art wall directions typically do not contain spaces between repeating patterns. The decorative thermal print is printed utilizing digital files that allows for seamless printing of repeat patterns. Further, because the thermal printer utilized is continuous, repeat patterns are not limited to the diameter of printing rolls and thus can be in excess of 100 meters in length making the invention ideal for printing wall boarders that extend around the perimeter of a room without the need for a repeat or calendars that typically don't require a repeat

In a preferred embodiment of the invention, the thermal print comprises iron particles. Iron, cobalt and nickel particles have magnetic properties that allow for simple, ferrous-based magnets to adhere. By placing iron particles into the decorative thermal print, magnets can adhere to the surface of the decorative thermal print. The iron particles are preferably located in the pragmatic sheet or in the adhesive. Iron particles located in the adhesive layer can be hidden from view utilizing an opaque pragmatic sheet. An example of the utility of a decorative element containing iron particles is a printed children's storybook containing text, images and graphics that is adhered to the walls of a child's room. The child could interact with the decorative images by placing characters what contain strip magnets into the story, allowing the child to physically and creatively interact with the story book adhered to the wall at a height that allows for the child to interact with the image. Another example would be a calendar adhered to the walls of a classroom were the date of the month is indicated with a physical marker containing a strip magnet. A further example would be a child growth chart utilizing magnets to indicate height progress over the progression of a few years.

In another preferred embodiment of the invention, the protective layer has a surface energy less than 40 dynes per centimeter, more preferably less than 37 dynes per centimeter. By providing a protective layer with a surface energy less than 40 dynes per centimeter, dry erase ink markers can be used to interact with the decoration allowing individuals to add transient information or hand draw images and the dry erase ink can be easily erased by hand using a damp or dry cloth. Surface energy less than 37 dyne per centimeter provides protection against unwanted or unexpected marking of decorations such as graffiti. The low surface energy protective materials are preferably transparent polymers with a low surface energy such as fluorinated polymers or polymers containing lubricants such as waxes.

In a further embodiment of the invention, the decorative thermal print comprises a phosphorescent material. Phosphorescent materials are those containing atoms that absorb energy followed by emission of electromagnetic energy. The emitted electromagnetic energy continues for some time after the source of excitation as been removed. In phosphorescent materials, the excited atoms have relatively long lifetimes before they make the transition to lower energy states. The incorporation of phosphorescent materials into the thermal print allows for sunlight or room light to be absorbed by the thermal print and be emitted over time. An example would be a wall decoration that absorbs sunlight during the day and emits light energy at night in a pattern such as a star. The phosphorescent material preferably is located in or adjacent to the pragmatic layer toward the side bearing the imaging layer. Thermal imaging dyes containing a UV absorbing material are preferably utilized to print the Phosphorescent material because the phosphorescent material will tend to emit in a pattern, emitting more energy in areas that are not printed, thus providing a pattern, graphic or text message that is illuminated during low ambient light conditions.

In a further embodiment of the invention, the protective layer preferably has a textured surface. A textured protective layer provides decorative element that has a high reflective haze and thus lowers the image contrast and significantly reduces unwanted glare from the decorative element that would reduce the image quality of the decorative element. A textured protective layer is preferably accomplished by first thermally printing the decorative media and secondly, embossing the surface of the textured media with embossing rollers designed to provide the desired texture. The embossing rollers may be located with the thermal printer or could be located outside the printer, further providing additional customization choices for consumers. Preferred examples include a texture that is cloth-like or a texture that has wallpaper like appearance.

In another embodiment of the invention, the protective layer preferably has a glossy surface. Glossy protective surfaces preferably have a surface Ra of between 0.07 and 1.8 micrometers. Glossy surfaces are typically utilized for high quality graphics and text. Glossy surfaces also are useful when the ambient lighting is uniform and has an even intensity. The decorative thermal print preferably has a combination of both glossy and textured surfaces. The glossy and textured surfaces can be in registration with specific image content. For example, a wall border containing images of people and graphic content such as cartoon characters could have texture surfaces in registration with the images of people and have glossy surfaces in registration with the cartoon characters.

In another embodiment of the invention, the pragmatic sheet is printed with a template prior to printing the thermal image. A pragmatic sheet with an ink printed template allows for insertion of images into an existing scene such as a calendar, storyboard, cartoon, or organizational chart for example. The ink printed pragmatic sheet is preferably printed with inks using an ink jet printer or printing press. The inks from an ink jet printer or printing press allow for a wider color gamut and higher density black for high quality text. The pragmatic sheet is preferably printed with the inks and then over coated with an image receiving layer for the transfer printing of thermal dyes. The imaging receiving layer is adjacent to the ink printed template layer and may be applied by a coating method or uniformly printed utilizing ink jet printing.

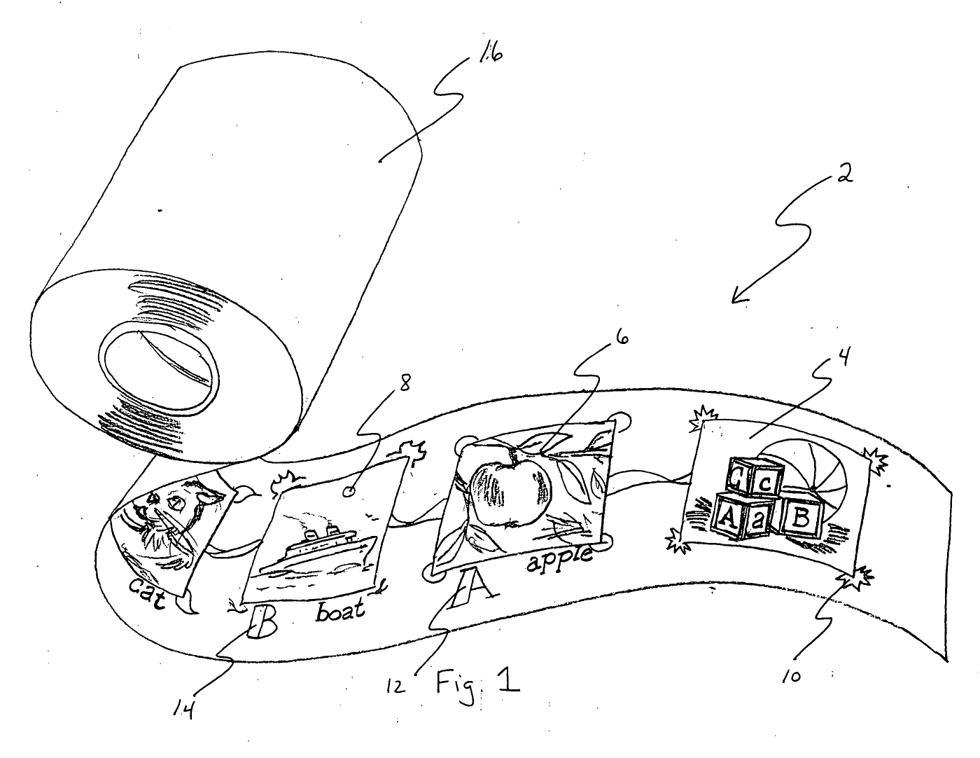

FIG. 1 is an illustration of a decorative thermal print 2 in which printed consumer custom image content 4,6 and 8 corresponds to a thermal dye transfer printed templates 10, 12 and 14. The decorative thermal print 2 is wound into a roll 16. The decorative thermal print wound into roll 16 allows for easy consumer application to desired surfaces such as painted walls, car bodies, school lockers or furniture. Printed consumer custom image content 4, 6 and 8 can be imported from both analog image capture and digital image capture methods and may be further altered using known image editing software.

In a further preferred embodiment of the invention, the pragmatic sheet comprises an electro-luminescent web material. By applying a voltage to the electro luminescent pragmatic sheet, the decorative thermal print can be illuminated from the backside eliminating the need for a light box as an illumination source. Electro-luminescent pragmatic sheets are constructed of a layered material that when assembled with a power supply, produce light. An electro luminescent powed coating, typically phosphor, is positioned between two electrode layers. One electrode is opaque and the other is transparent. When the electro luminescent pragmatic sheet is connected to an electrical current, typically a 280VAC/650 Hz supply, the powder glows, providing cool, uniform, backlighting for thermal dye transfer printed images.

The pragmatic sheet of the invention preferably comprises vinyl. Like all plastic materials, vinyl results from a series of processing steps that convert hydrocarbon-based raw materials (petroleum, natural gas or coal) into unique synthetic products called polymers. The vinyl polymer is unusual, however, because it is based only in part on hydrocarbon feed stocks. Generally, the other half of the vinyl polymer is based on the natural element chlorine. Chlorine gives vinyl two advantages. First, chlorine is derived from brine, which is a solution of common salt and water, and a readily available, inexpensive commodity. Thus, vinyl is less sensitive to fluctuations in the world oil market than are totally oil dependent polymers. Second, chlorine has excellent inherent flame retardant properties. These properties are passed on directly to vinyl products, making vinyl an excellent choice for applications such as electrical conduit and wiring that require high resistance to ignition and flame spread.

When vinyl is utilized for the pragmatic sheet, a plasticizer containment layer located between the pragmatic sheet and the thermal imaging layers is preferred. Thermal dyes, used to print images, graphics and text have very high mobility into polymer containing plasticizer, significantly reducing image quality. By utilizing a plasticizer-containing layer, the thermal dyes remain in the imaging layers. Preferred water soluble polymers suitable for use in the barrier layer of the invention include polyvinyl alcohols and copolymers thereof, gelatin, gelatin derivatives, casein, agar, sodium alginate, starch, acrylic acid containing polymers, maleic anhydride containing polymers, hydrophilic cellulose esters such as carboxymethylcellulose, hydroxypropyl methyl cellulose, and polyacrylamides. Perferred water dispersible polymers include polyesters, particularly polyesterionomers, polyurethanes, and latex polymers having hydrophilic functionality such as (meth)acrylic acid containing polymers, maleic anhydride containing polymers, itaconic acid containing polymers, styrene sulfonic acid containing polymers.

In another embodiment of the invention, the adhesive layer preferably comprises a pressure sensitive adhesive. Pressure sensitive adhesives allow the invention materials to be utilized, for example, as a pressure sensitive label, wall decoration material or automobile graphics material. Suitable pressure sensitive adhesives may be inorganic or organic, natural or synthetic, which is capable of bonding the image to the desired surface-by-surface attachment. Examples of inorganic pressure sensitive adhesives are soluble silicates, ceramic and thermosetting powdered glass. Organic pressure sensitive adhesives may be natural or synthetic. Examples of natural organic pressure sensitive adhesives include bone glue, soybean starch cellulosics, rubber latex, gums, terpene, mucilages and hydrocarbon resins. Examples of synthetic organic pressure sensitive adhesives include elastomer solvents, polysulfide sealants, theromplastic resins such as isobutylene and polyvinyl acetate, theromsetting resins such as epoxy, phenoformaldehyde, polyvinyl butyral and cyanoacrylates and silicone polymers.

For single or multiple layer pressure sensitive adhesive systems, the preferred pressure sensitive adhesive composition is selected from the group consisting of natural rubber, syntheic rubber, acrylics, acrylic copolymers, vinyl polymers, vinyl acetate-, urethane, acrylate-type materials, copolymer mixtures of vinyl chloride-vinyl acetate, polyvinylidene, vinyl acetate-acrylic acid copolymers, styrene butadiene, carboxylated stryrene butadiene copolymers, ethylene copolymers, polyvinyl alcohol, polyesters and copolymers, cellulosic and modified cellulosic, starch and modified starch compounds, epoxies, polyisocyanate, polyimides.

When thermal dye transfer printing is utilized to print the imaging member of the invention dye donor elements are utilized. Dye-donor elements that are used with the element of the invention conventionally comprise a support having thereon a dye containing layer. Any dye can be used in the dye-donor employed in the invention, provided it is transferable to the layer by the action of heat. Especially good results have been obtained with sublimable dyes. Dye donors applicable for use in the present invention are described, e.g., in U.S. Pat. Nos. 4,916,112; 4,927,803; and 5,023,228. As noted above, dye-donor elements are used to form a dye transfer image. Such a process comprises image-wise-heating a dye-donor element and transferring a dye image to an element as described above to form the dye transfer image. In a preferred embodiment of the thermal dye transfer method of printing, a dye donor element is employed which compromises a poly(ethylene terephthalate) support coated with sequential repeating areas of cyan, magenta, and yellow dye, and the dye transfer steps are sequentially performed for each color to obtain a three-color dye transfer image. When the process is only performed for a single color, then a monochrome dye transfer image is obtained.

Thermal printing heads, which can be used to transfer dye from dye-donor elements to receiving elements of the invention, are available commercially. There can be employed, for example, a Fujitsu Thermal Head (FTP-040 MCS001), a TDK Thermal Head F415 HH7-1089, or a Rohm Thermal Head KE 2008-F3. Alternatively, other known sources of energy for thermal dye transfer may be used, such as lasers as described in, for example, GB No. 2,083,726A.

A thermal dye transfer assemblage comprises (a) a dye-donor element, and (b) a element as described above, the element being in a superposed relationship with the dye-donor element so that the dye layer of the donor element is in contact with the dye image-receiving layer of the receiving element.

When a three-color image is to be obtained, the above assemblage is formed on three occasions during the time when heat is applied by the thermal printing head. After the first dye is transferred, the elements are peeled apart. A second dye-donor element (or another area of the donor element with a different dye area) is then brought in register with the element and the process repeated. The third color is obtained in the same manner.

In a preferred embodiment, fiducial marks are thermal dye transfer printed at the edges of the decorative element for the purpose of alignment of two continuous printed sections of the decorative element on a surface. The alignment fiducial allows for continuous sections to be placed in very close proximity with each in order to reduce the visual impact of any seam, while maintaining the continuous flow of the image, graphic or text. The fiducial preferably have a line width of less than 100 micrometers to reduce the visual impact of the fiducial at a viewing distance of 1 meter or greater. The fiducial preferably is printed utilizing yellow dye to also reduce the visual impact of the fiducial mark.

Printing the decorative thermal print is preferably accomplished by having consumers interact with a decorative design kiosk either in person or utilizing the Internet. A method for forming a personalized wallpaper comprising providing a digital file template, providing a digital file containing personal images, inserting said images into the template, printing said images continuously utilizing a thermal imaging printer, to form a continuous decorative thermal wallpaper print, wherein said images are preferably printed on a thermal print material comprising a continuous thermal print material comprising a thermal dye receiving layer, a pragmatic layer, and an adhesive layer on the opposite side of said pragmatic layer from said thermal dye receiving layer. The digital template allows for the combination of personal images into a software program that will provide layouts for the images or insert the images into existing templates that will provide new utility for the images such as a calendar or wallpaper border for home decoration.

In some embodiments of the invention the decorative thermal print may exhibit high mechanical modulus, surface roughness, electrical conductivity, ductility, elasticity, and low oxygen and water vapor transmission. Further, the decorative thermal print material may be used in applications requiring a printed length greater than 30 meters such as airplane streamers, advertisements, bus decorations, dance choreography step patterns, teaching aid, auto pin striping tape, road markings, window glass decorations, military identification for large vehicles, house wraps, graphic detailing for playing fields, ceiling decorations, wire covering and optical films for large displays.

The invention has been described in detail with particular reference to certain preferred embodiments thereof, but it will be understood that variations and modifications can be effected within the spirit and scope of the invention.

1. A decorative thermal print comprising a continuous thermal print material comprising a thermal image on a pragmatic layer, a protective layer over the print, and an adhesive layer on the opposite side of said pragmatic layer from said image.

2. The print of claim 1 wherein said thermal print comprises a repeating pattern without spacing between pattern repeats.

3. The print of claim 1 wherein said thermal print comprises iron particles.

4. The print of claim 1 wherein said thermal print comprises a protective layer having a low surface energy of less than 40 dynes per centimeter.

5. The print of claim 1 wherein said thermal print comprises a phosphorescent material.

6. The print of claim 1 wherein said thermal print comprises a protective layer having a textured surface.

7. The print of claim 1 wherein said thermal print comprises a protective layer having a glossy surface.

8. The print of claim 1 wherein said thermal print has printed alignment fiducial marks printed at the edges of said print.

9. The print of claim 1 wherein said pragmatic layer is provided with a ink printed template.

10. The print of claim 1 wherein said pragmatic layer comprises a vinyl sheet.

11. The print of claim 1 further comprising a release sheet over said adhesive layer.

12. The print of claim 1 wherein said adhesive layer comprises a water-activating adhesive.

13. The print of claim 1 wherein said adhesive layer comprises a pressure-sensitive adhesive.

14. The print of claim 1 wherein said thermal image is of photographic quality.

15. A method for forming a personalized wallpaper comprising providing a digital file template, providing a digital file containing personal images, inserting said images into the template, printing said images continuously utilizing a thermal imaging printer, to form a continuous decorative thermal wallpaper print, wherein said images are printed on a thermal print material comprising a continuous thermal print material comprising a thermal dye receiving layer, a pragmatic layer, and an adhesive layer on the opposite side of said pragmatic layer from said thermal dye receiving layer.

16. The method of claim 15 wherein said pragmatic sheet comprises a ink printed template.

17. The method of claim 15 wherein said adhesive layer comprises a removalable pressure sensitive adhesive.

18. The method of claim 15 wherein said thermal dye receiving layer comprises a cross linked polyester-polyurethane copolymer.

19. The method of claim 15 wherein said thermal print comprises a repeating pattern without spacing between pattern repeats.
